(19) United States
(12) Patent Application Publication
(10) Pub. No.: US 2006/0080593 A1
(43) Pub. Date: Apr. 13, 2006

(54) System and method for generating computer-readable documents

(76) Inventors: Alexander Hudspith, London (GB); Michael J. Brown, London (GB)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/961,431

(22) Filed: Oct. 8, 2004

(51) Int. Cl. G06F 17/24; G06F 17/30; G06F 17/21

(52) U.S. Cl. 715/501.1; 715/513; 707/1; 707/10

(57) ABSTRACT

A system and method for generated computer-readable documents are disclosed which reveal a way to retrieve dynamically generated content for a web page locally from an application server. In particular, the present invention discloses a custom protocol that is used to insert the dynamically generated content stored locally by the application server into a computer-readable document, which may be a PDF document.

### FIELD OF THE INVENTION

This invention relates to generating computer-readable documents. In particular, this invention pertains to using a protocol that allows for simple and efficient retrieval of content stored locally that is inserted into a computer-readable document.

### BACKGROUND OF THE INVENTION

A standard format for locating and retrieving data located on networked computers is the use of a Uniform Resource Locator address (“URL”). A URL specifies the location of a file, query, or other resource located on any computer in a network. The URL has a format of X:Y, where “X” specifies the protocol to be used to retrieve the resource, and “Y” specifies a unique identifier associated with the resource. For example, the URL “http://www.webpage.com/index.htm” specifies that the hyptertext transfer protocol (“HTTP”) should be used to retrieve the resource identified by “www.webpage.com/index.htm”.

One example of a computer network is the Internet. The Internet has become a common and useful place to retrieve real-time information. For instance, people may obtain real-time stock quotes and charts depicting recent stock price history via a web page. Or, investors may obtain real-time graphs depicting current performance of their investment portfolio. However, content displayed on a web page is temporal, and users often print out the contents of a web page or save it as an HTML file on their hard disk drive to make the information permanent. However, printing out web pages and saving them as HTML often involves corruption of the formatting and appearance of the content.

One type of file format exists, however, that is capable of permanently storing content with precise formatting. This file format is called the Portable Document Format or PDF, as is known in the art. Conventionally, however, generation of PDF documents from real-time web-based content, including dynamically generated images, has been difficult, if not impossible. The reason for this difficulty will be described with reference to FIG. 1, which illustrates a common computer hardware arrangement used to provide content to users across the Internet. In this arrangement, a computer (“web server”) 101 running a web server program receives requests for content 102 from the Internet 103. The web server 101 routes the request 102 to a separate computer (“application server”) 104, which executes the applications that process the request and provide the requested content 106. Because the code and data on the application server 104 is more sensitive and/or valuable than that on the web server 101, a firewall 105, known in the art, filters communication between the web server 101 and the application server 104 and acts as a security measure. Accordingly, it is advantageous to have separate computers 101 and 104 acting as the web server and application server, respectively. Once the content is generated by the application server 104, it is transmitted to the web server 101, which transmits the content as a response 106 back to the user or machine that requested it.

When the request 102 is a request for a PDF document generated from real-time, dynamically-generated content from a web page, the web server 101 routes the request to a PDF generation program executed by the application server 104. Such PDF generation programs, such as Apache FOP, require the use of a URL to identify the location of images or other content to be imported into the PDF. However, because of firewall constraints 105, the application server 104 cannot retrieve such content from the web server 101. Further, URL protocols, such as HTTP and File Transfer Protocol (“FTP”), are designed for network-based communication, making retrieval of information from the application server itself 104, i. e., retrieval of information not on a network, awkward and difficult.

For example, one conventional scheme for using a URL to request data from the application server itself 104 is to run the web server program on the application server 104, thereby combining the functions performed by computer 101 and computer 104 into a single computer. In this situation, an HTTP request transmitted by the PDF generator running on the application server 104 is sent to and processed by the web server program running on the same computer. However, this solution is awkward in that it requires running a web server program on the application server, which increases complexity and compromises the effectiveness of the firewall 105 and security generally.

To circumvent these constraints limiting the application server's ability to retrieve content from the web server 101 or itself using conventional URL protocols, content may be retrieved from another computer 107 located behind the firewall 105 and connected to the application server 104. However, this arrangement requires the additional computer 107, thereby increasing the complexity of the system.

Another conventional protocol, which is not necessarily network-based, is the “file:” protocol known in the art. In most operating systems, this protocol facilitates retrieval of content stored locally by only certain kinds of memories, most commonly a hard disk or disk drive, such as a CD or DVD drive. However, reading and writing to files on these types of memories is slow, especially when the demand for content is great. Although some operating systems allow for “memory-mapped” file systems, which may be used to allow the “file:” protocol to retrieve content from faster RAM, a memory-mapped file system is not the best design choice for all content-providing systems, such as a web site, and the process for setting up a memory-mapped file system is cumbersome. Another drawback of the “file:” protocol is that it requires each piece of content, such as a chart or image, to be stored as its own separate file. Consequently, it precludes storing a plurality of partial, intermediate, or different pieces of content, such as multiple intermediate charts, portions of an image, or a chart and an image, in a single file. Therefore, it can be seen that the “file:” protocol is limited to particular supported types of memories, and is inflexible in the manner in which content may be stored.

Accordingly, a need in the art exists for a simple, flexible, and efficient way to retrieve images and other locally stored content, such as dynamically generated images, which may be incorporated into a PDF document.

### SUMMARY OF THE INVENTION

These problems are addressed and a technical solution achieved in the art by a system and method for generating computer-readable documents. According to the invention, a custom protocol is disclosed that allows a computer-readable document generation application, such as a PDF generator, to retrieve content locally without having to communicate with an external computer or having to execute a web server on the computer executing the document generation application.

According to one embodiment of the invention, an identifier is associated with content to be inserted into a computer-readable document, which may be a PDF. The content and associated identifier are stored in a computer-accessible memory managed by a local computer. An address of the content is defined by associating the identifier with a protocol, where the protocol is configured to allow retrieval of data from the computer-accessible memory managed by the local computer. The address is embedded into a template in a manner that defines where the content is to appear in the computer-readable document. The computer-readable document is then generated from the template by performing actions comprising inserting the content into the computer-readable document at a location identified by the embedded address.

According to one embodiment of the invention, the content is converted into a byte stream and assigned an identifier. The byte stream and associated identifier are stored in a map, i.e., a data structure for storing a set of associations, in a computer-accessible memory. A template generator inserts the identifier with a reference to an associated protocol into the template. A document generator generates the computer-readable document from the template by performing actions including: receiving the template from the template generator; extracting, from the template, the identifier with the reference to the associated protocol; transmitting the identifier with the reference to the associated protocol to a protocol handler; receiving the byte stream from the protocol handler; and inserting the byte stream into the computer-readable document.

In one embodiment of the invention, the map is stored in a high-speed volatile memory, and the protocol allows retrieval of the content from such high-speed volatile memory, thereby reducing response times. In this embodiment, content may be rapidly added to the map and inserted into the computer-readable document. Consequently, dynamically generated content, such as content displayed on a web page, may simply and efficiently be incorporated into a PDF document.

### BRIEF DESCRIPTION OF THE DRAWINGS

A more complete understanding of this invention may be obtained from a consideration of this specification taken in conjunction with the drawings, in which:

FIG. 1 illustrates a conventional web-content providing arrangement;

FIG. 2 illustrates a web-content-providing arrangement according to an embodiment of the invention; and

FIG. 3 illustrates a process flow according to an embodiment of the invention.

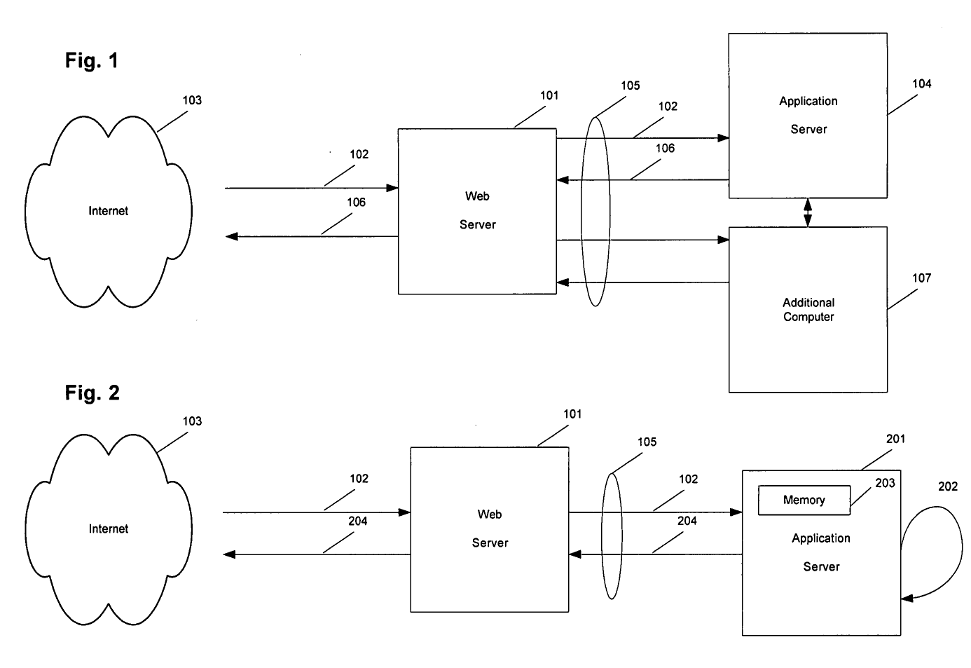

### DETAILED DESCRIPTION OF THE EXEMPLARY EMBODIMENT(S) OF THE INVENTION

The present invention facilitates generation of computer-readable documents that incorporate dynamically generated content. Computer-readable documents include, but are not limited to, PDF documents, word processing documents, such as Microsoft Word or Corel Wordperfect documents, spreadsheet documents, such as Microsoft Excel documents, presentation documents, such as Microsoft Powerpoint documents, and image files, such JPEG, BMP, GIF, TIF, etc. Microsoft Word, Microsoft Excel, and Microsoft Powerpoint are trademarks of the Microsoft Corporation. Although the invention is often described in the context of PDF documents, one skilled in the art will appreciate that the invention is not limited to any particular computer-readable document, and that the invention applies to generation of other types of computer-readable documents.

The term “content” is intended to include, but not be limited to, for example, images, charts, graphs, text, and other objects that may be incorporated into a computer-readable document. Dynamically generated content refers to content that is rapidly generated upon request and accessible for use, and is often not needed for storage beyond its immediate use, such as being inserted into a computer-readable document. For example, if a user requests a chart showing the performance history of his or her investment portfolio, such chart may be dynamically generated in that it may be generated on the fly and subsequently deleted from memory after it has been displayed to the user and/or incorporated into a PDF document. Although the invention provides significant benefits for incorporating dynamically generated content into computer-readable documents, one skilled in the art will appreciate that the invention is not limited to dynamically generated content, and includes within its scope any content stored by a computer-accessible memory managed by the computer generating the computer-readable document.

The term “computer” is intended to include any data processing device, such as a desktop computer, a laptop computer, a personal digital assistant, or any other device capable of processing data, whether implemented with electronics, optics, both, or otherwise. The term “computer-accessible memory” is intended to include any readable and writable computer-accessible data storage device, whether volatile or nonvolatile, electronic, optical, or otherwise, including but not limited to, floppy disks, hard disks, CD-RWs, writable DVDs, PROMs, EPROMs, and RAMs.

The manner in which the present invention facilitates generation of computer-readable documents that incorporate dynamically generated content will be described in detail beginning with FIG. 2. As shown in the embodiment of FIG. 2, a computer 101 (“web server”) configured as a web server is communicatively connected to computers (not shown) via, for example, the Internet 103. The web server 101 is also communicatively connected to an application server 201. The term “communicatively connected” is intended to include any type of connection, whether wired or wireless, in which data may be communicated. Further, the term “communicatively connected” is intended to include a connection between devices or logical objects, such as processes, within a single computer or a connection between computers.

A request 102 from the Internet 103 for web content converted into a computer-readable document is received by the web server 101. Although described in the context of a web server 101 communicating with computers via the Internet 103, one skilled in the art will appreciate that any communicative connection between the web server 101 and other computers will suffice. The request 102 may originate from a user viewing a chart on a web page showing the performance history of his or her investment portfolio. Because such information is specific to the user, it is advantageously dynamically generated as the user requests it by either the web server 101 or the application server 201, depending upon design choice. In this example, the user may select a “link” on the web page that initiates a request for the chart and other information displayed on the web page as a computer-readable document, such as a PDF document. Upon selecting the “link,” the request 102 is transmitted from the user's computer (not shown) to the web server 101.

Upon receipt of the request 102, the web server 101 translates the request 102, if necessary, and forwards it on to the application server 201. If the web server 101 generated the chart and/or other information displayed on the user's web page, it transmits this data to the application server 201 for incorporation into the computer-readable document. In this situation, the web server 101 transmits this data because the application server 201 is unable to request such data from the web server 101 due to the firewall 105. On the other hand, if the application server 201 generated the chart and/or other information displayed on the user's web page, it is already available to the application server 201 and need not be transmitted.

The content displayed on the web page, which is to be incorporated into the requested computer-readable document, is stored in a computer-accessible memory 203 communicatively connected to and managed by the application server 201. Such computer-accessible memory 203 is advantageously the application server's 201 internal RAM in order to decrease response times. However, one skilled in the art will appreciate that such memory 203 may be any computer-accessible memory communicatively connected to and managed by the application server 201. Computer-accessible memory 203 is also referred to herein as a “local” memory.

Once the application server 201 receives the request, it generates the computer-readable document using the content stored in its computer-accessible memory 203 using a URL protocol that allows it to do so. As shown by the looping arrow 202, this protocol allows the application server 201 to retrieve the dynamically generated content from its own computer-accessible memory 203, thereby circumventing the problem of having a firewall 105 preventing access to such content from the web server 101. Further, a web server program need not be executed on the application server 201 in order to retrieve this content. Once the computer-readable document is generated by the application server 201, it is transmitted to the web server 101 at 204. The web server 101 then incorporates the computer-readable document into a formal response to the user or machine that requested it.

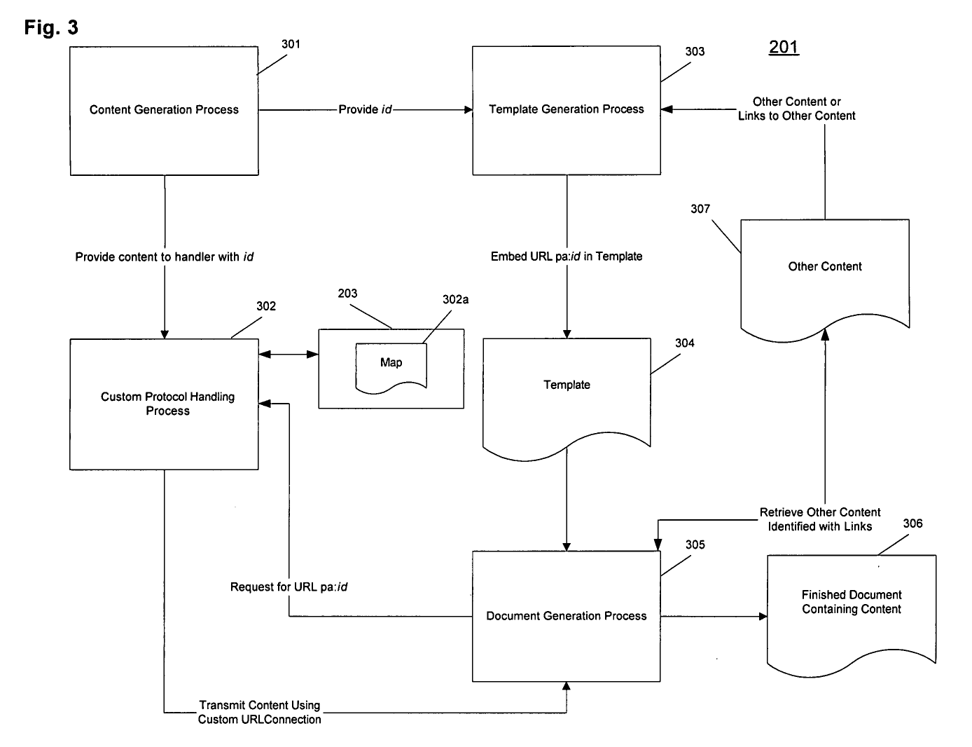

The processing performed by the application server 201 now will be described with reference to FIG. 3. In the embodiment shown in FIG. 3, the processing is executed within a Java Runtime Environment (“JRE”), known in the art. “Java” is a trademark of Sun Microsystems Inc. The inventive protocol, which allows simple local data retrieval shown by looping arrow 202 of FIG. 2, is registered as a custom protocol “pa” in Java that instructs the JRE to send all URLs containing “pa” as the protocol to a custom protocol handling process 302. Although the invention is described in the context of using a JRE and implementing processes in Java, one skilled in the art will appreciate that the concept of the invention may be implemented in other environments and programming languages, and, consequently, that the invention is not so limited. One skilled in the art will also appreciate that the invention is not limited to the name of the custom protocol. Further, although the invention is described in the context of using URLs to identify the locations of the content stored in memory 203, one skilled in the art will appreciate that other addressing conventions may be used and that the invention is not limited to any one particular addressing convention.

The custom protocol handling process 302 manages a map 302a within the computer-accessible memory 203 that associates a unique identifier, referred to herein as “id”, with each piece of content that is to be or may be inserted into a computer-readable document. Accordingly, the URLs of the content stored in the map 302a have the format “pa:id”, where “pa” is the custom protocol and “id” is the unique identifier of the particular content desired. Contrary to the conventional protocols, the custom “pa” protocol allows content to be easily retrieved from the computer-accessible memory 203 managed by the application server 201 without the use of a web server program. Further, because the custom “pa” protocol is configured to store an id and an associated byte stream in a table that may be stored in any kind of computer-accessible memory, it is not limited to any particular type of computer-accessible memory 203, as is the conventional “file:” protocol, which depends upon a structured file system.

The processing performed by application server 201 may begin with a content generation process 301 that may generate the requested content, if necessary, and optionally converts the dynamically generated content into a format compatible with the computer-readable document into which it will be inserted. In the scenario where the computer-readable document is a PDF document, the content generation process 301 may convert the content into a byte stream. If the content generation process 301 does not perform the conversion function, such function may be performed by another process at another time, if necessary. According to one embodiment, the content generation process 301 assigns a unique identifier “id” to each piece of content. Further, a unique “id” may be assigned to a plurality of partial, intermediate, or different pieces of content. For example, a single “id” may be easily assigned to a byte stream associated with a portion of an image, multiple intermediate charts, or a chart and an image. Consequently, the invention is not limited to a one-to-one correspondence between an “id” and one complete unit of content. An example of software to perform the content generation process is JClass Chart known in the art. (JClass Chart is a trade mark of Quest Software.)

The content and id are transmitted to the custom protocol handling process 302 that inserts them into the map 302a. The map 302a may be represented, for example, as shown in Table I below, where the byte streams in the second column represent the sequence of zeros and ones that define the appearance of the content.

TABLE I

| Unique Identifier | Content |
|---|---|
| 001 | <byte stream of image 1> |
| 002 | <byte stream of chart 1> |
| 003 | <byte stream of image 2 followed by chart 2> |

The content generation process 301 transmits the id to a template generation process 303. The template generation process 303 generates a template 304 to be used for generating the computer-readable document. In the scenario where the computer-readable document is a PDF document, the template generation process 303 generates a PDF blueprint 304, which in one embodiment is an XML document describing the layout of the content to be included in the PDF document. Anywhere content stored in map 302a is to be inserted into the computer-readable document, the template generation process 303 inserts the URL “pa:id” where id is the identifier of the content to be inserted. An example of the template generation process 303 is Apache's Velocity program known in the art.

Other content 307 not stored in the map 302a, such as content that need not be dynamically generated and/or is not specific to the particular user making the request, is also inserted into the template 304. Depending upon the type of other content 307, such content may be inserted into the template 304 as a link, e.g., a URL for images, or inserted directly, such as for text. Examples of this other content 307 may include, but are not limited to, standard text, static, i.e., non-dynamically-generated images, and/or formatting used to generate the computer-readable document into which dynamically-generated content is inserted. For instance, assume that a user is viewing a web page including a chart showing the user's investment performance history. Although the chart shown on the web page is unique to the user and is likely dynamically generated, the web page may have a standard title, such as “Your Investment Performance History,” that is displayed to all users viewing this web page. Accordingly, when the user requests that the web page be converted into a computer-readable document, such as a PDF document, the dynamically-generated chart is stored in the map 302a and is identified in the template 304 as discussed. However, the standard title is advantageously not stored in the map 302a and is shown being inserted into template 304 as other content 307. Because the other content 307 is typically needed on a more permanent basis than dynamically generated content, it may be stored in a non-volatile memory, such as a hard disk. However, any computer-readable memory, including memory 203, will do.

In the situation where the other content 307 includes static images, the same problem exists of not being able to access them using convention URL protocols, such as HTTP and FTP, as it does for dynamically-generated images. Accordingly, another custom protocol and protocol handling process, besides “pa” an its associated handling protocol 302 may be used to retrieve such images. This other custom protocol and handling process may operate exactly the same as the “pa” protocol and handling process 302, except that instead of using a dynamic “id” to address the unique byte stream, a static location is used to address the file in which the static image is stored. An example may be: <fo:external-graphic src=“url(pares:///com/jpm/alm/analyser/resources/heat_banner.gif)”/>, where “pares” is the other custom protocol. Other than the fact that the static image is a file at a known location, this separate custom protocol and associated handling process operate in the same way that the “pa” protocol operates.

The template 304 is transmitted to a computer-readable-document generation process 305 that generates the requested computer-readable document 306 based upon the template 304. An example of the computer-readable-document generation process 305 is Apache FOP, known in the art, which requires the input template 304 to be in XSL:FO format, which is a standard layout page description language known in the art. This format requires that links to images be in a URL format. Accordingly, any references to URLs having the format pa:id in the template 304 are recognized as a URL by the JRE and are sent to the registered custom protocol handling process 302. The handling process 302 matches the id in the map 302a and returns the associated content to the document generation process 305, which inserts such content into the computer-readable document. Accordingly, the document generation process 305 receives links to content as URLs, as is required, while allowing the content to be retrieved from a local memory 302a without the use of a web server.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

What is claimed is:

1. A method for inserting content into a computer-readable document, the method executable by a computer and comprising:
associating an identifier with the content;
storing the content and associated identifier in a computer-accessible memory managed by the computer;
defining a location of the content in the computer-accessible memory by associating the identifier with a protocol, the protocol configured to allow retrieval of data from the computer-accessible memory managed by the computer;
retrieving the content from the computer-accessible memory using the defined location; and
inserting the content retrieved from the computer-accessible memory into the computer-readable document.

2. The method of claim 1, further comprising
transforming the content into a format compatible with the computer-readable document,
wherein the inserting step inserts the transformed content into the computer-readable document.

3. The method of claim 1, wherein the location is a URL.

4. The method of claim 1, wherein the computer-accessible memory is a volatile memory.

5. The method of claim 1, wherein the computer-readable document has a Portable Document Format (“PDF”) format.

6. The method of claim 1, wherein the content is an image.

7. The method of claim 1, wherein the content is dynamically generated.

8. A method for generating a computer-readable document, the method comprising:
receiving a template of the computer-readable document, the template comprising an address of content to be inserted into the computer-readable document, the address comprising: (a) an identifier associated with the content and (b) a reference to a protocol, the protocol configured to allow retrieval of data from a local computer-accessible memory;
extracting the address from the template;
transmitting the address;
receiving the content in response to the transmitted address; and
generating the computer-readable document from the template by performing actions comprising inserting the received content into the computer-readable document.

9. The method of claim 8, wherein the computer-accessible memory is a volatile memory.

10. The method of claim 8, wherein the template is an XML document.

11. The method of claim 8, wherein the address is a URL.

12. The method of claim 8, wherein the content is an image.

13. The method of claim 8, wherein the content is dynamically generated.

14. The method of claim 8, wherein the computer-readable document has a Portable Document Format (“PDF”) format.

15. A method for generating a computer-readable document, the method executable by a computer and comprising:
associating an identifier with content;
storing the content and associated identifier in a computer-accessible memory managed by the computer;
defining an address of the content by associating the identifier with a protocol, the protocol configured to allow retrieval of data from the computer-accessible memory managed by the computer;
embedding the address of the content into a template; and
generating the computer-readable document from the template by performing actions comprising inserting the content into the computer-readable document at a location identified by the embedded address.

16. The method of claim 15, further comprising:
transforming the content into a format compatible with the computer-readable document,
wherein the transformed content is inserted into the computer-readable document.

17. The method of claim 15, wherein the computer-accessible memory is a volatile memory.

18. The method of claim 15, wherein the template is an XML document.

19. The method of claim 15, wherein the address is a URL.

20. The method of claim 15, wherein the content is an image.

21. The method of claim 15, wherein the content is dynamically generated.

22. The method of claim 15, wherein the computer-readable document has a Portable Document Format (“PDF”) format.

23. A system for generating a computer-readable document, the system comprising:
a first computer;
a computer-accessible memory;
a second computer communicatively connected to the second computer and the computer-accessible memory,
wherein the second computer manages the computer-accessible memory, the first computer transmits a request for a computer-readable document to the second computer, the second computer generates the computer-readable document by performing actions comprising the method of claim 1, and the second computer transmits the generated computer-readable document to the first computer.

24. A system for generating a computer-readable document, the system executable by a computer and comprising:
a content generation process that generates content and associates an identifier with the content;
a protocol handler that receives the content and associated identifier from the content generation process and stores the content and associated identifier in a computer-accessible memory managed by the computer;
a template generation process that receives the identifier from the content generation process and inserts the identifier with a reference to an associated protocol into a template, the protocol configured to allow retrieval of data from the computer-accessible memory; and
a document generation process that generates the computer-readable document by performing actions comprising: receiving the template from the template generation process; extracting, from the template, the identifier with the reference to the associated protocol; transmitting the identifier with the reference to the associated protocol to the protocol handler; receiving the content from the protocol handler; and inserting the content into the computer-readable document.

25. The system of claim 24, wherein the content generation process transforms the content into a format compatible with the computer-readable document, and the document generation process inserts the transformed content into the computer-readable document.

26. The system of claim 24, wherein the computer-accessible memory is a volatile memory.

27. The system of claim 24, wherein the template is an XML document.

28. The system of claim 24, wherein the identifier and reference to the associated protocol is a URL.

29. The system of claim 24, wherein the content is an image.

30. The system of claim 24, wherein the content is dynamically generated.

31. The system of claim 24, wherein the computer-readable document has a Portable Document Format (“PDF”) format.

32. A method for generating a PDF document, the method executable by a computer and comprising:
transforming an image into a PDF-compatible format,
associating an identifier with the transformed image;
storing the transformed image and associated identifier in a computer-accessible memory managed by the computer;
defining a URL by associating the identifier with a protocol, the protocol configured to allow retrieval of data from the computer-accessible memory managed by the computer;
embedding the URL of the transformed image into a template, the template being an XML document; and
generating the PDF document from the template by performing actions comprising inserting the transformed image into the PDF document at a location identified by the embedded URL.

33. A system for generating a PDF document, the system executable by a computer and comprising:
a content generation process that transforms an image into a PDF-compatible format and associates an identifier with the transformed image;
a protocol handler that receives the transformed image and associated identifier from the content generation process and stores the transformed image and associated identifier in a computer-accessible memory managed by the computer;
a template generation process that receives the identifier from the content generation process and inserts a URL into a template, the template being an XML document, the URL comprising the identifier and a reference to the associated protocol, and the protocol being configured to allow retrieval of data from the computer-accessible memory; and
a document generation process that generates the PDF document by performing actions comprising: receiving the template from the template generation process; extracting, from the template, the URL; transmitting the URL to the protocol handler; receiving the transformed image from the protocol handler; and inserting the transformed image into the PDF document.
